(19) United States
(12) Patent Application Publication
(10) Pub. No.: US 2025/0223785 A1
(43) Pub. Date: Jul. 10, 2025

(54) CONTROL SYSTEM OF WORK MACHINE, WORK MACHINE, AND CONTROL METHOD OF WORK MACHINE

(71) Applicant: Komatsu Ltd., Tokyo (JP)

(72) Inventors: Masaki Yamawaki, Tokyo (JP); Azumi Ichikawa, Tokyo (JP); Takashi Yokoo, Tokyo (JP); Yoshito Kumakura, Tokyo (JP); Yasufumi Uehara, Tokyo (JP); Kenichi Tsunoda, Tokyo (JP); Daiki Arimatsu, Tokyo (JP)

(73) Assignee: Komatsu Ltd., Tokyo (JP)

(21) Appl. No.: 18/853,809

(22) PCT Filed: Aug. 29, 2023
(86) PCT No.: PCT/JP2023/031182

§ 371 Date: Oct. 3, 2024

(30) Foreign Application Priority Data
Sep. 26, 2022 (JP) 2022-152594

(51) Int. Cl. E02F 9/26; E02F 9/20

(52) U.S. Cl. CPC E02F 9/262; E02F 9/2025

(57) ABSTRACT

Disclosed is a control system of a work machine, the control system including: a construction data storage unit that stores a plurality of design surfaces set as a construction object of the work machine; a selection unit that selects at least two design surfaces to be offset in directions that are perpendicular to the design surfaces from among the plurality of design surfaces; and an offset control unit that edits the selected design surfaces and offsets the edited design surfaces in the perpendicular directions.

### FIELD

The present disclosure relates to a control system of a work machine, the work machine, and a control method of the work machine.

### BACKGROUND

In a technical field related to a work machine, a technique of constructing a construction object based on a target construction surface is known. As the technique of constructing the construction object based on the target construction surface, a machine guidance technique of presenting a guidance image indicating a relative position between the target construction surface and a bucket of working equipment to an operator of the work machine, and a machine control technique of performing assist control of an operation of the operator so that the bucket of the working equipment moves along the target construction surface are known. Patent Literature 1 discloses an example of the machine guidance technique.

### CITATION LIST

### Patent Literature

Patent Literature 1: JP 2014-074318 A

### SUMMARY

### Technical Problem

A target construction surface may be defined by a plurality of design surfaces having mutually different gradients. In addition, there is a case in which it is desired to generate a new target construction surface by offsetting each of the plurality of design surfaces in a direction perpendicular to the design surface (normal direction). When the plurality of design surfaces is offset in the perpendicular directions at once, the design surfaces may intersect each other or may be separated from each other, and the target construction surface may not be appropriately generated. However, an easy method of changing the shape of the target construction surface to eliminate the intersection or the separation between the countless design surfaces has not been established. Furthermore, when the target construction surface is formed of many design surfaces, offsetting all of the target construction surfaces in the perpendicular directions results in a great computational load.

An object of the present disclosure is to easily offset each of a plurality of design surfaces in a perpendicular direction.

### Solution to Problem

In order to achieve an aspect of the present invention, a control system of a work machine, the control system comprises: a construction data storage unit that stores a plurality of design surfaces set as a construction object of the work machine; a selection unit that selects at least two design surfaces to be offset in directions that are perpendicular to the design surfaces from among the plurality of design surfaces; and an offset control unit that edits the selected design surfaces and offsets the edited design surfaces in the perpendicular directions.

### Advantageous Effects of Invention

According to the present disclosure, it is possible to easily generate a new target construction surface obtained by offsetting a plurality of design surfaces in perpendicular directions.

### BRIEF DESCRIPTION OF DRAWINGS

FIG. 1 is a perspective view illustrating a work machine according to an embodiment.

FIG. 2 is a schematic diagram illustrating the work machine according to the embodiment.

FIG. 3 is a diagram illustrating a cab of the work machine according to the embodiment.

FIG. 4 is a block diagram illustrating a control system of the work machine according to the embodiment.

FIG. 5 is a diagram schematically illustrating a target construction surface.

FIG. 6 is a diagram illustrating a problem according to the embodiment.

FIG. 7 is a flowchart illustrating a control method of the work machine according to the embodiment.

FIG. 8 is a perspective view schematically illustrating a design surface selected by a selection unit according to the embodiment.

FIG. 9 is a perspective view schematically illustrating a design surface before being offset by an offset control unit according to the embodiment and a design surface after being offset by the offset control unit.

FIG. 10 is a side view schematically illustrating the design surface before being offset by the offset control unit according to the embodiment and the design surface after being offset by the offset control unit.

FIG. 11 is a side view schematically illustrating a design surface after being edited and offset.

FIG. 12 is a plan view schematically illustrating the design surface after being edited and offset.

FIG. 13 is a diagram schematically illustrating an example of a processing method when two design surfaces intersect each other.

FIG. 14 is a block diagram illustrating a computer system according to the embodiment.

### DESCRIPTION OF EMBODIMENTS

Hereinafter, embodiments according to the present disclosure will be described with reference to the drawings, but the present disclosure is not limited to the embodiments. The components of the embodiments described below can be appropriately combined with each other. In addition, some components may not be used.

### [Work Machine]

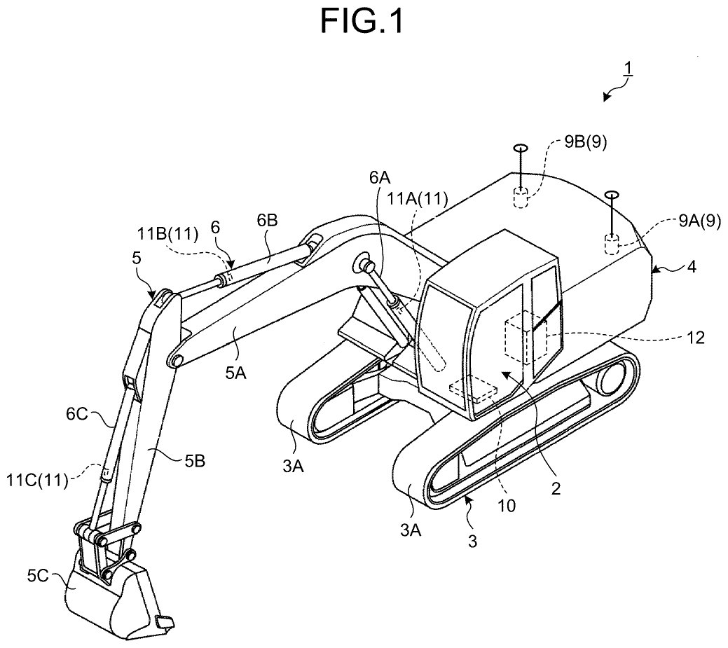

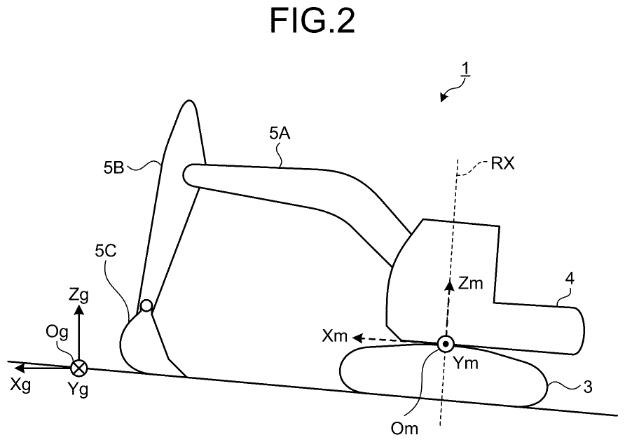

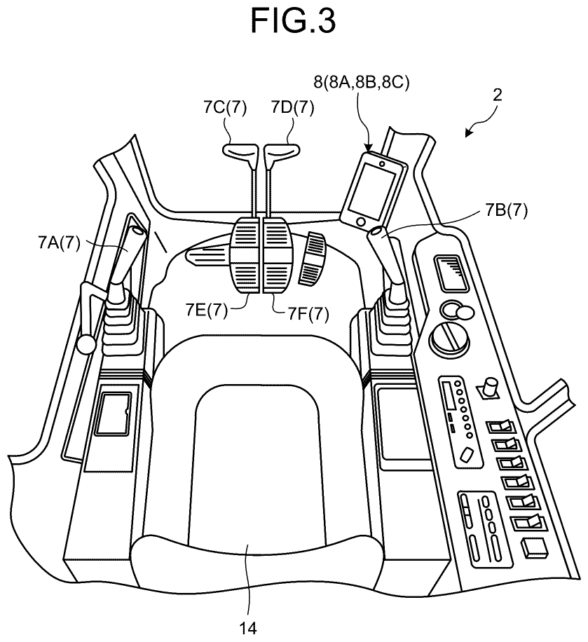

FIG. 1 is a perspective view illustrating a work machine 1 according to an embodiment. FIG. 2 is a schematic diagram illustrating the work machine 1 according to the embodiment. FIG. 3 is a diagram illustrating a cab 2 of the work machine 1 according to the embodiment.

The work machine 1 is operated at a work site. In the embodiment, the work machine 1 is an excavator. In the following description, the work machine 1 is appropriately referred to as an excavator 1.

The excavator 1 includes a traveling body 3, a swing body 4, working equipment 5, a hydraulic cylinder 6, an operating device 7, an in-vehicle monitor 8, a position sensor 9, an inclination sensor 10, a posture sensor 11, and a control device 12.

As illustrated in FIG. 2, a three-dimensional site coordinate system (Xg, Yg, Zg) is defined at the work site. A three-dimensional vehicle body coordinate system (Xm, Ym, Zm) is defined in the swing body 4.

The site coordinate system is configured by an Xg axis extending from a site reference point Og defined at the work site to the north and south, a Yg axis extending from the site reference point Og to the east and the west, and a Zg axis extending vertically from the site reference point Og.

The vehicle body coordinate system is configured by an Xm axis extending in the forward-and-rearward direction of the swing body 4 from a representative point Om defined in the swing body 4, a Ym axis extending in the left-and-right direction of the swing body 4 from the representative point Om, and a Zm axis extending in the upward-and-downward direction of the swing body 4 from the representative point Om. With reference to the representative point Om of the swing body 4, the +Xm direction is the front side of the swing body 4, the −Xm direction is the rear side of the swing body 4, the +Ym direction is the left side of the swing body 4, the −Ym direction is the right side of the swing body 4, the +Zm direction is the upper side of the swing body 4, and the −Zm direction is the lower side of the swing body 4.

The traveling body 3 travels while supporting the swing body 4. The traveling body 3 includes a pair of crawler belts 3A. By the rotation of the crawler belts 3A, the traveling body 3 performs traveling movement. The traveling movement of the traveling body 3 includes forward movement and rearward movement. The excavator 1 can move within the work site by the traveling body 3.

The swing body 4 is supported by the traveling body 3. The swing body 4 is disposed above the traveling body 3. The swing body 4 performs swing movement around a swing axis RX while being supported by the traveling body 3. The swing axis RX is parallel to the Zm axis. The swing movement of the swing body 4 includes a left swing movement and a right swing movement. The cab 2 is provided in the swing body 4.

The working equipment 5 is supported by the swing body 4. The working equipment 5 performs work. In the embodiment, the work performed by the working equipment 5 includes excavation work of excavating a construction object and loading work of loading an excavated object onto a loading object.

The working equipment 5 includes a boom 5A, an arm 5B, and a bucket 5C. The proximal end portion of the boom 5A is rotatably connected to a front portion of the swing body 4. The proximal end portion of the arm 5B is rotatably connected to the distal end portion of the boom 5A. The proximal end portion of the bucket 5C is rotatably connected to the distal end portion of the arm 5B.

The hydraulic cylinder 6 causes the working equipment 5 to move. The hydraulic cylinder 6 includes a boom cylinder 6A, an arm cylinder 6B, and a bucket cylinder 6C. The boom cylinder 6A causes the boom 5A to perform a raising movement and a lowering movement. The arm cylinder 6B causes the arm 5B to perform an excavation movement and a dumping movement. The bucket cylinder 6C causes the bucket 5C to perform the excavation movement and the dumping movement. The proximal end portion of the boom cylinder 6A is connected to the swing body 4. The distal end portion of the boom cylinder 6A is connected to the boom 5A. The proximal end portion of the arm cylinder 6B is connected to the boom 5A. The distal end portion of the arm cylinder 6B is connected to the arm 5B. The proximal end portion of the bucket cylinder 6C is connected to the arm 5B. The distal end portion of the bucket cylinder 6C is connected to the bucket 5C.

As illustrated in FIG. 3, the operating device 7 is disposed in the cab 2. The operating device 7 is operated to cause at least one of the traveling body 3, the swing body 4, and the working equipment 5 to move. The operating device 7 is operated by an operator in the cab 2. The operator can operate the operating device 7 while sitting on a driver seat 14 disposed in the cab 2.

The operating device 7 includes a left working lever 7A and a right working lever 7B operated for the movement of the swing body 4 and the working equipment 5, a left traveling lever 7C and a right traveling lever 7D operated for the movement of the traveling body 3, and a left foot pedal 7E and a right foot pedal 7F.

When the left working lever 7A is operated in the forward-and-rearward direction, the arm 5B performs the dumping movement or the excavation movement. When the left working lever 7A is operated in the left-and-right direction, the swing body 4 performs the left swing movement or the right swing movement. When the right working lever 7B is operated in the left-and-right direction, the bucket 5C performs the excavation movement or the dumping movement. When the right working lever 7B is operated in the forward-and-rearward direction, the boom 5A performs the lowering movement or the raising movement. Note that the swing body 4 may perform the left swing movement or the right swing movement when the left working lever 7A is operated in the forward-and-rearward direction, and the arm 5B may perform the dumping movement or the excavation movement when the left working lever 7A is operated in the left-and-right direction.

When the left traveling lever 7C is operated in the forward-and-rearward direction, the crawler belt 3A on the left side of the traveling body 3 performs the forward movement or the rearward movement. When the right traveling lever 7D is operated in the forward-and-rearward direction, the crawler belt 3A on the right side of the traveling body 3 performs the forward movement or the rearward movement.

The left foot pedal 7E is operated in conjunction with the left traveling lever 7C. The right foot pedal 7F is operated in conjunction with the right traveling lever 7D. The traveling body 3 may perform the forward movement or the rearward movement by operating the left foot pedal 7E and the right foot pedal 7F.

The in-vehicle monitor 8 is disposed in the cab 2. The in-vehicle monitor 8 is disposed on the right front side of the driver seat 14. The in-vehicle monitor 8 includes a display device 8A, an input device 8B, and an alarm device 8C.

The display device 8A displays prescribed display data. As the display device 8A, a flat panel display such as a liquid crystal display (LCD) or an organic electroluminescence display (OELD) is exemplified.

The input device 8B generates input data by being operated by the operator. Examples of the input device 8B include a button switch, a computer keyboard, and a touch panel.

The alarm device 8C outputs a prescribed alarm. In the embodiment, the alarm device 8C is a sound output device that outputs an alarm sound. Note that the alarm device 8C may be a light emitting device that outputs alarm light.

The position sensor 9 detects the position of the swing body 4 in the site coordinate system. The position sensor 9 detects the position of the swing body 4 in the site coordinate system using a global navigation satellite system (GNSS). The global navigation satellite system includes a global positioning system (GPS). The global navigation satellite system detects a position defined by coordinate data of latitude, longitude, and altitude. The position sensor 9 includes a GNSS receiver that receives GNSS radio waves from a GNSS satellite. The position sensor 9 is disposed in the swing body 4. In the embodiment, the position sensor 9 is disposed in a counterweight of the swing body 4.

The position sensor 9 includes a first position sensor 9A and a second position sensor 9B. The first position sensor 9A and the second position sensor 9B are disposed at different positions in the swing body 4. In the embodiment, the first position sensor 9A and the second position sensor 9B are disposed at intervals in the left-and-right direction in the swing body 4. The first position sensor 9A detects a first measured position indicating a position in which the first position sensor 9A is disposed. The second position sensor 9B detects a second measured position indicating a position in which the second position sensor 9B is disposed.

The inclination sensor 10 detects acceleration and angular velocity of the swing body 4. The inclination sensor 10 includes an inertial measurement unit (IMU). The inclination sensor 10 is disposed in the swing body 4. In the embodiment, the inclination sensor 10 is installed below the cab 2.

The posture sensor 11 detects the posture of the working equipment 5. The posture of the working equipment 5 includes an angle of the working equipment 5. The posture sensor 11 includes a first posture sensor 11A that detects an angle of the boom 5A relative to the swing body 4, a second posture sensor 11B that detects an angle of the arm 5B relative to the boom 5A, and a third posture sensor 11C that detects an angle of the bucket 5C relative to the arm 5B. The posture sensor 11 may be a stroke sensor that detects a stroke of the hydraulic cylinder 6 or a potentiometer that detects the angle of the working equipment 5.

### [Control System]

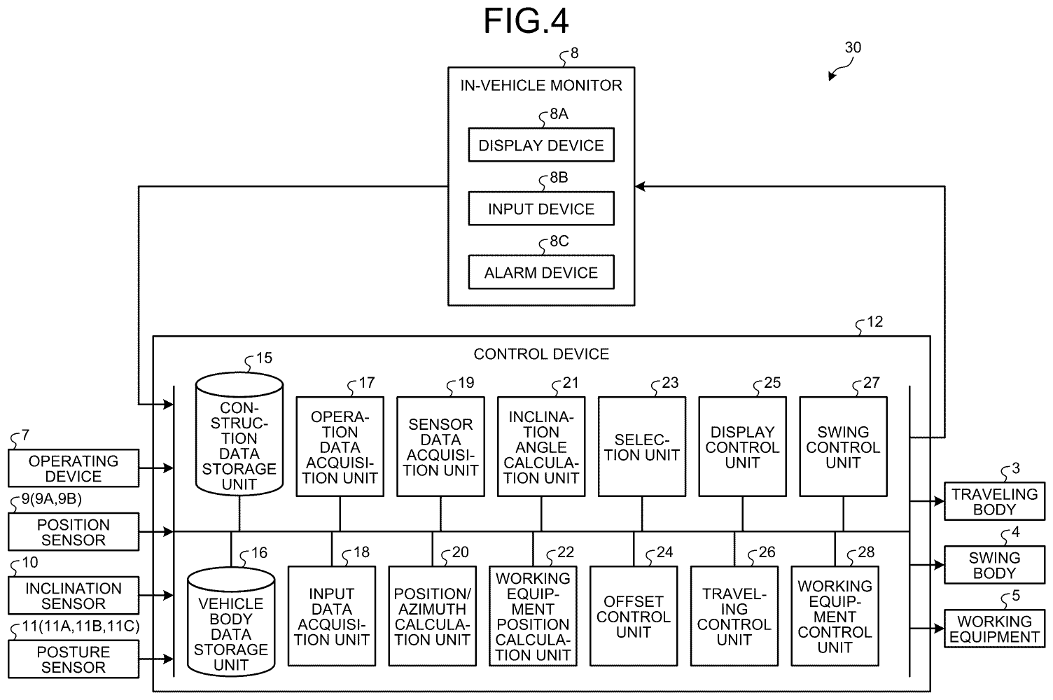

FIG. 4 is a block diagram illustrating a control system 30 of the work machine 1 according to the embodiment. The excavator 1 includes the control system 30. The control system 30 includes the in-vehicle monitor 8, the position sensor 9, the inclination sensor 10, the posture sensor 11, and the control device 12. The control device 12 controls the excavator 1. The control device 12 includes a computer system.

The control device 12 includes a construction data storage unit 15, a vehicle body data storage unit 16, an operation data acquisition unit 17, an input data acquisition unit 18, a sensor data acquisition unit 19, a position/azimuth calculation unit 20, an inclination angle calculation unit 21, a working equipment position calculation unit 22, a selection unit 23, an offset control unit 24, a display control unit 25, a traveling control unit 26, a swing control unit 27, and a working equipment control unit 28.

The construction data storage unit 15 stores a plurality of design surfaces set at the work site. The plurality of design surfaces is set as a construction object of the excavator 1 at the work site. The design surface is created by a computer system existing outside the excavator 1. The design surface is created in an external facility of the excavator 1, such as a design room. The design surface is a surface defined in the site coordinate system. A target construction surface indicating a target shape of the construction object is defined by the plurality of design surfaces. The excavator 1 excavates the construction object based on the target construction surface.

The vehicle body data storage unit 16 stores vehicle body data of the excavator 1. The vehicle body data of the excavator 1 includes dimensions of the working equipment 5. The dimensions of the working equipment 5 include a length of the boom 5A, a length of the arm 5B, and a length of the bucket 5C. In addition, the vehicle body data of the excavator 1 includes dimensions of the traveling body 3 and dimensions of the swing body 4.

The operation data acquisition unit 17 acquires operation data generated by operating the operating device 7.

The input data acquisition unit 18 acquires input data generated by operating the input device 8B.

The sensor data acquisition unit 19 acquires detection data of the position sensor 9, detection data of the inclination sensor 10, and detection data of the posture sensor 11.

The position/azimuth calculation unit 20 calculates a position and an azimuth angle of the swing body 4 in the site coordinate system based on the detection data of the position sensor 9. As described above, the position sensor 9 includes the GNSS receiver that receives GNSS radio waves. The position/azimuth calculation unit 20 calculates the position and the azimuth angle of the swing body 4 based on the GNSS radio waves. The azimuth angle of the swing body 4 is, for example, an azimuth angle of the swing body 4 based on the Xg axis.

The position/azimuth calculation unit 20 calculates the position of the swing body 4 based on at least one of the first measured position detected by the first position sensor 9A and the second measured position detected by the second position sensor 9B. The position/azimuth calculation unit 20 calculates the azimuth angle of the swing body 4 based on a relative position between the first measured position detected by the first position sensor 9A and the second measured position detected by the second position sensor 9B.

The inclination angle calculation unit 21 calculates an inclination angle of the swing body 4 based on the detection data of the inclination sensor 10. The inclination angle of the swing body 4 includes a roll angle and a pitch angle of the swing body 4. The roll angle refers to an inclination angle of the swing body 4 in an inclination direction around the Xg axis. The pitch angle refers to an inclination angle of the swing body 4 in an inclination direction around the Yg axis. The inclination angle calculation unit 21 calculates the roll angle and the pitch angle of the swing body 4 based on the detection data of the inclination sensor 10.

The working equipment position calculation unit 22 calculates a position of the working equipment 5 based on the position of the work machine 1 calculated by the position/azimuth calculation unit 20. In the embodiment, the working equipment position calculation unit 22 calculates the position of the working equipment 5 in the site coordinate system based on the vehicle body data of the excavator 1 stored in the vehicle body data storage unit 16, the position and azimuth angle of the swing body 4 calculated by the position/azimuth calculation unit 20, the inclination angle of the swing body 4 calculated by the inclination angle calculation unit 21, and the detection data of the posture sensor 11. The position of the working equipment 5 includes the position of the bucket 5C. The position of the bucket 5C includes the position of a blade edge provided at a distal end portion of the bucket 5C.

The selection unit 23 selects at least two design surfaces to be offset in the directions that are perpendicular to the design surfaces from among the plurality of design surfaces stored in the construction data storage unit 15. The design surface to be offset is designated by an operator. The operator operates the input device 8B to designate the design surface to be offset. The input data from the input device 8B is acquired by the input data acquisition unit 18. The selection unit 23 selects, based on the input data acquired by the input data acquisition unit 18, at least two design surfaces to be offset in the directions that are perpendicular to the design surfaces from among the plurality of design surfaces stored in the construction data storage unit 15.

The offset control unit 24 edits at least two design surfaces selected by the selection unit 23 and then offsets the edited design surfaces in the perpendicular directions.

The display control unit 25 controls the display device 8A of the in-vehicle monitor 8. The display control unit 25 causes the display device 8A to display prescribed display data. The display control unit 25 can cause the display device 8A to display each of the design surfaces before being offset and the design surfaces after being offset.

The traveling control unit 26 controls the traveling body 3 based on the operation data of the operating device 7 acquired by the operation data acquisition unit 17.

The swing control unit 27 controls the swing body 4 based on the operation data of the operating device 7 acquired by the operation data acquisition unit 17.

The working equipment control unit 28 controls the working equipment 5. Controlling the working equipment 5 includes controlling the hydraulic cylinder 6. The working equipment control unit 28 controls the working equipment 5 based on the design surfaces edited and offset by the offset control unit 24. The working equipment control unit 28 controls the working equipment 5 based on the operation data of the operating device 7 acquired by the operation data acquisition unit 17. In addition, the working equipment control unit 28 performs assist control of an operation of the operator so that the bucket 5C of the working equipment 5 moves along the design surfaces. For example, the working equipment control unit 28 performs assist control of the working equipment 5 so that the blade edge of the bucket 5C calculated by the working equipment position calculation unit 22 follows the design surfaces offset by the offset control unit 24.

### [Offset of Design Surface]

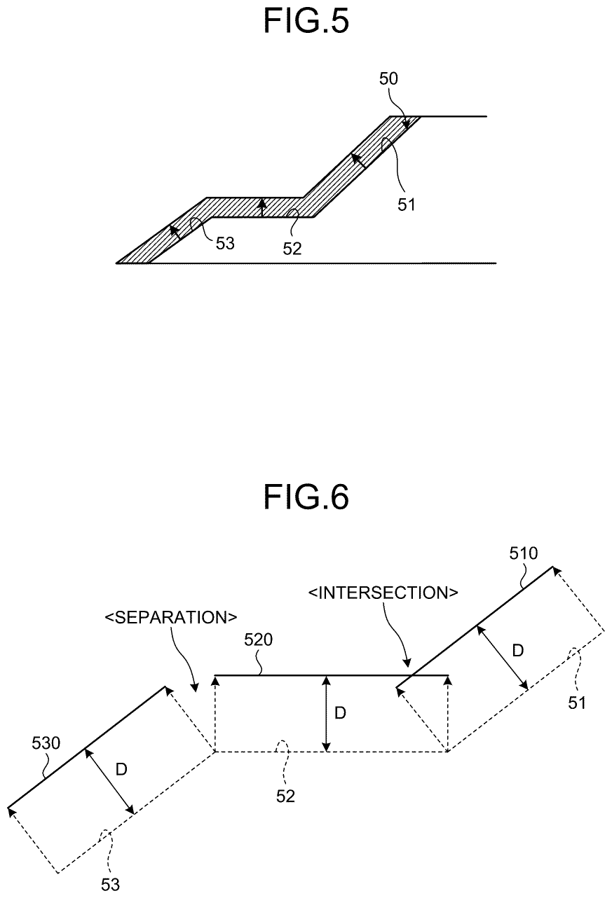

FIG. 5 is a diagram schematically illustrating a target construction surface 50. As illustrated in FIG. 5, the target construction surface 50 indicating a target shape of a construction object is defined by a plurality of design surfaces 51, 52, and 53. Each of the plurality of design surfaces 51, 52, and 53 is a plane. The design surface 52 is adjacent to the design surface 51. The design surface 53 is adjacent to at least one of the design surface 51 and the design surface 52. In the example illustrated in FIG. 5, the design surface 53 is adjacent to the design surface 52. The target construction surface 50 is defined by the plurality of design surfaces 51, 52, and 53 having mutually different gradients.

As illustrated in FIG. 5, there is a case in which it is desired to generate a new target construction surface by offsetting each of the plurality of design surfaces 51, 52, and 53 in a direction perpendicular to each of the design surfaces 51, 52, and 53 (normal direction). That is, there is a case in which it is desired to offset the design surface 51 in a direction perpendicular to the design surface 51 (normal direction), offset the design surface 52 in a direction perpendicular to the design surface 52 (normal direction), and offset the design surface 53 in a direction perpendicular to the design surface 53 (normal direction).

FIG. 6 is a diagram illustrating a problem according to the embodiment. As illustrated in FIG. 6, when the design surface 51 is offset by an offset amount D in the direction perpendicular to the design surface 51 while maintaining the size and shape of the design surface 51, a design surface 510 is generated. When the design surface 52 is offset by the offset amount D in the direction perpendicular to the design surface 52 while maintaining the size and shape of the design surface 52, a design surface 520 is generated. When the design surface 53 is offset by the offset amount D in the direction perpendicular to the design surface 53 while maintaining the size and shape of the design surface 53, a design surface 530 is generated. When the plurality of design surfaces 51, 52, and 53 are offset in the perpendicular directions at once while maintaining the sizes and shapes of the plurality of design surfaces 51, 52, and 53, there is a possibility that the design surface 510 and the design surface 520 after being offset intersect each other, or the design surface 520 and the design surface 530 after being offset are separated from each other, as illustrated in FIG. 6. When the design surfaces 510, 520, and 530 after being offset intersect each other or are separated from each other, there is a possibility that the target construction surface 50 is not appropriately generated. To eliminate the intersection or the separation of the design surfaces 510, 520, and 530, it is conceivable to take a measure of enlarging or reducing each of the design surfaces 510, 520, and 530. However, each of the design surfaces 510, 520, and 530 is a polygonal surface formed by a plurality of triangles, and it is not possible to eliminate the intersection or the separation by simply enlarging or reducing the surfaces. In addition, when the shape of the design surface is partially changed to eliminate the intersection or the separation, it is necessary to calculate a configuration of a triangle that realizes the shape after the change, and a large computational load may be caused in a complicated design surface shape.

Therefore, the offset control unit 24 edits the design surfaces 51, 52, and 53 and then offsets the design surfaces 51, 52, and 53 in the perpendicular directions. The editing of each of the design surfaces 51, 52, and 53 by the offset control unit 24 includes changing each of the design surfaces 510, 520, and 530 after being offset to a quadrangular shape based on vertices of each of the design surfaces 51, 52, and 53 before being offset.

### [Control Method]

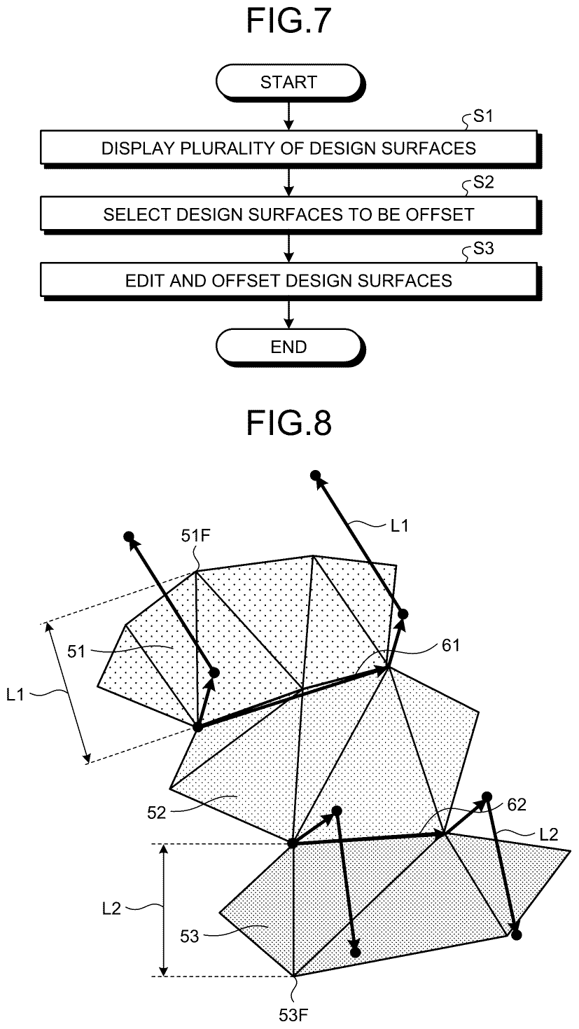

FIG. 7 is a flowchart illustrating a control method of the excavator 1 according to the embodiment. The construction data storage unit 15 stores a plurality of design surfaces. The display control unit 25 causes the display device 8A to display the plurality of design surfaces stored in the construction data storage unit 15 (Step S1).

An operator of the excavator 1 operates the input device 8B and selects at least two design surfaces to be offset in the perpendicular directions from among the plurality of design surfaces displayed on the display device 8A. The input data from the input device 8B is acquired by the input data acquisition unit 18. The selection unit 23 selects, based on the input data acquired by the input data acquisition unit 18, at least two design surfaces to be offset in the perpendicular directions from among the plurality of design surfaces stored in the construction data storage unit 15 (Step S2).

FIG. 8 is a perspective view schematically illustrating the design surfaces 51, 52, and 53 selected by the selection unit 23 according to the embodiment. In the embodiment, the selection unit 23 selects the design surface 51, the design surface 52 adjacent to the design surface 51, and the design surface 53 adjacent to at least one of the design surface 51 and the design surface 52. In the example illustrated in FIG. 8, the design surface 53 is adjacent to the design surface 52.

Each of the design surface 51, the design surface 52, and the design surface 53 is a plane. The design surface 51 includes six triangles adjacent to each other. The six triangles configuring the design surface 51 are arranged in the same plane. The design surface 52 includes five triangles adjacent to each other. The five triangles configuring the design surface 52 are arranged in the same plane. The design surface 53 includes four triangles adjacent to each other. The four triangles configuring the design surface 53 are arranged in the same plane.

The outer shape of each of the design surface 51, the design surface 52, and the design surface 53 is a polygon. Each of the design surface 51, the design surface 52, and the design surface 53 has at least five vertices. That is, each of the design surface 51, the design surface 52, and the design surface 53 has a polygonal shape having five or more sides. In the embodiment, the outer shape of the design surface 51 is a heptagon. The outer shape of the design surface 52 is a hexagon. The outer shape of the design surface 53 is a hexagon. The design surface 51 and the design surface 52 are adjacent to each other such that one side of the design surface 51 coincides with one side of the design surface 52. The design surface 52 and the design surface 53 are adjacent to each other such that one side of the design surface 52 coincides with one side of the design surface 53. The design surface 51 and the design surface 52 share a side 61. The design surface 52 and the design surface 53 share a side 62. The side 61 connects two vertices of the design surface 51 and two vertices of the design surface 52. The side 62 connects two vertices of the design surface 52 and two vertices of the design surface 53.

The offset control unit 24 edits the design surfaces 51, 52, and 53 selected in Step S2 and offsets the edited design surfaces 51, 52, and 53 in the perpendicular directions (Step S3).

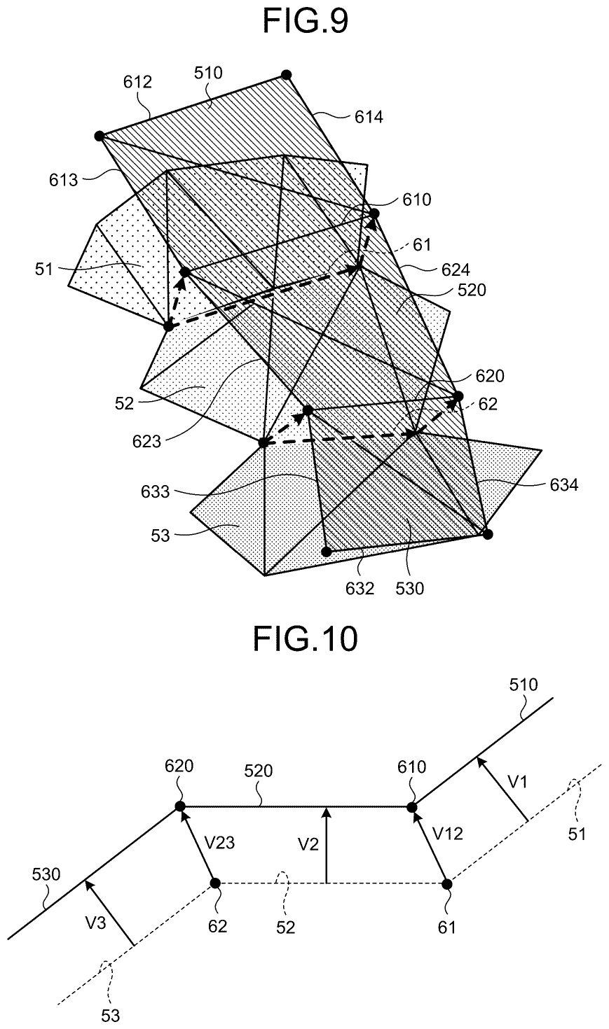

FIG. 9 is a perspective view schematically illustrating the design surfaces 51, 52, and 53 before being offset by the offset control unit 24 according to the embodiment and the design surfaces 510, 520, and 530 after being offset by the offset control unit 24. FIG. 10 is a side view schematically illustrating the design surfaces 51, 52, and 53 before being offset by the offset control unit 24 according to the embodiment and the design surfaces 510, 520, and 530 after being offset.

The editing of the design surfaces 51, 52, and 53 by the offset control unit 24 includes forming each of the design surfaces 510, 520, and 530 after being offset into a quadrangular shape based on vertices of each of the design surfaces 51, 52, and 53 before being offset.

The outer shape of the design surface 510 is a quadrangle. The design surface 510 includes a first side 610, a second side 612 opposite the first side 610, a third side 613 connecting one end of the first side 610 to one end of the second side 612, and a fourth side 614 connecting the other end of the first side 610 to the other end of the second side 612. The dimension and the direction of the first side 610 of the design surface 510 are equal to the dimension and the direction of the side 61 of the design surface 51. The first side 610 of the design surface 510 and the side 61 of the design surface 51 are parallel to each other. The first side 610 and the second side 612 are parallel to each other. The dimension of the first side 610 is equal to the dimension of the second side 612. The first side 610 and the third side 613 are orthogonal to each other. The first side 610 and the fourth side 614 are orthogonal to each other. The third side 613 and the fourth side 614 are parallel to each other. The dimension of the third side 613 of the design surface 510 and the dimension of the fourth side 614 of the design surface 510 are equal to a distance L1 illustrated in FIG. 8. The distance L1 is a distance between the side 61 and a vertex 51F of the design surface 51 in a direction parallel to the design surface 51 and orthogonal to the side 61. The vertex 51F is a vertex that is the farthest from the side 61 in the direction parallel to the design surface 51 and orthogonal to the side 61 among the seven vertices of the design surface 51.

The outer shape of the design surface 530 is a quadrangle. The design surface 530 includes a fifth side 620, a sixth side 632 opposite the fifth side 620, a seventh side 633 connecting one end of the fifth side 620 to one end of the sixth side 632, and an eighth side 634 connecting the other end of the fifth side 620 to the other end of the sixth side 632. The dimension and the direction of the fifth side 620 of the design surface 530 are equal to the dimension and the direction of the side 62 of the design surface 53. The fifth side 620 of the design surface 530 and the side 62 of the design surface 53 are parallel to each other. The fifth side 620 and the sixth side 632 are parallel to each other. The dimension of the fifth side 620 is equal to the dimension of the sixth side 632. The fifth side 620 and the seventh side 633 are orthogonal to each other. The fifth side 620 and the eighth side 634 are orthogonal to each other. The seventh side 633 and the eighth side 634 are parallel to each other. The dimension of the seventh side 633 of the design surface 530 and the dimension of the eighth side 634 of the design surface 530 are equal to a distance L2 illustrated in FIG. 8. The distance L2 is a distance between the side 62 and a vertex 53F of the design surface 53 in a direction parallel to the design surface 53 and orthogonal to the side 62. The vertex 53F is a vertex that is the farthest from the side 62 in the direction parallel to the design surface 53 and orthogonal to the side 62 among the six vertices of the design surface 53.

The outer shape of the design surface 520 is a quadrangle. The design surface 520 includes the first side 610, the fifth side 620 opposite the first side 610, a ninth side 623 connecting one end of the first side 610 to one end of the fifth side 620, and a tenth side 624 connecting the other end of the first side 610 and the other end of the fifth side 620.

The design surface 510 is a plane offset by a predetermined offset amount in a direction perpendicular to the design surface 51 (normal direction). The design surface 510 and the design surface 51 are parallel to each other. The design surface 520 is a plane offset by a predetermined offset amount in a direction perpendicular to the design surface 52 (normal direction). The design surface 520 and the design surface 52 are parallel to each other. The design surface 530 is a plane offset by a predetermined offset amount in a direction perpendicular to the design surface 53 (normal direction). The design surface 530 and the design surface 53 are parallel to each other. The design surface 510 and the design surface 520 share the first side 610. The design surface 520 and the design surface 530 share the fifth side 620.

As illustrated in FIG. 10, when a normal vector perpendicular to the design surface 51 is defined as a normal vector V1, a normal vector perpendicular to the design surface 52 is defined as a normal vector V2, and a normal vector perpendicular to the design surface 53 is defined as a normal vector V3, an offset vector from the side 61 to the first side 610 corresponds to a combined vector V12 of the normal vector V1 and the normal vector V2. The combined vector V12 is calculated from an offset amount D1 of the design surface 51, an offset amount D2 of the design surface 52, and an angle θ12 formed by the normal vector V1 and the normal vector V2 based on the following mathematical formula (1).

$$V 12 = \frac{1}{( 1 - {cos}^{2} θ12 )} \cdot \{ ( D 1 - D 2 \cdot cos θ12 ) \cdot V 1 + ( D 2 - D 1 \cdot cos θ12 ) \cdot V 2 \} \qquad ( 1 )$$

When an offset amount from the design surface 51 to the design surface 510 is equal to an offset amount from the design surface 52 to the design surface 520, an offset direction from the side 61 to the first side 610 with respect to the horizontal plane (a direction of the combined vector V12 with respect to the horizontal plane) corresponds to a direction of a vector sum (V1+V2) of the normal vector V1 with respect to the horizontal plane and the normal vector V2 with respect to the horizontal plane. The offset vector from the side 62 to the fifth side 620 corresponds to a combined vector V23 of the normal vector V2 and the normal vector V3. The combined vector V23 is calculated from the offset amount D2 of the design surface 52, an offset amount D3 of the design surface 53, and an angle θ23 formed by the normal vector V2 and the normal vector V3 based on the following mathematical formula (2).

$$V 23 = \frac{1}{( 1 - {cos}^{2} θ23 )} \cdot \{ ( D 2 - D 3 \cdot cos θ23 ) \cdot V 2 + ( D 3 - D 2 \cdot cos θ23 ) \cdot V 3 \} \qquad ( 2 )$$

When an offset amount from the design surface 52 to the design surface 520 is equal to an offset amount from the design surface 53 to the design surface 530, an offset direction from the side 62 to the fifth side 620 with respect to the horizontal plane (a direction of the combined vector V23 with respect to the horizontal plane) corresponds to a direction of a vector sum (V2+V3) of the normal vector V2 with respect to the horizontal plane and the normal vector V3 with respect to the horizontal plane.

As described above, according to the embodiment, each of the plurality of design surfaces 51, 52, and 53 is edited based on a predetermined rule, whereby each of the plurality of design surfaces 51, 52, and 53 is easily offset in the perpendicular direction. An appropriate target construction surface is generated by the plurality of design surfaces 510, 520, and 530.

After each of the design surfaces 51, 52, and 53 is edited into a quadrangle and is offset in the perpendicular direction, the working equipment control unit 28 controls the working equipment 5 based on the design surfaces 510, 520, and 530 after being edited and offset. The working equipment control unit 28 performs assist control of the working equipment 5 so that the blade edge of the bucket 5C follows the design surfaces 510, 520, and 530.

[Processing when Two Design Surfaces after being Edited and Offset Intersect Each Other]

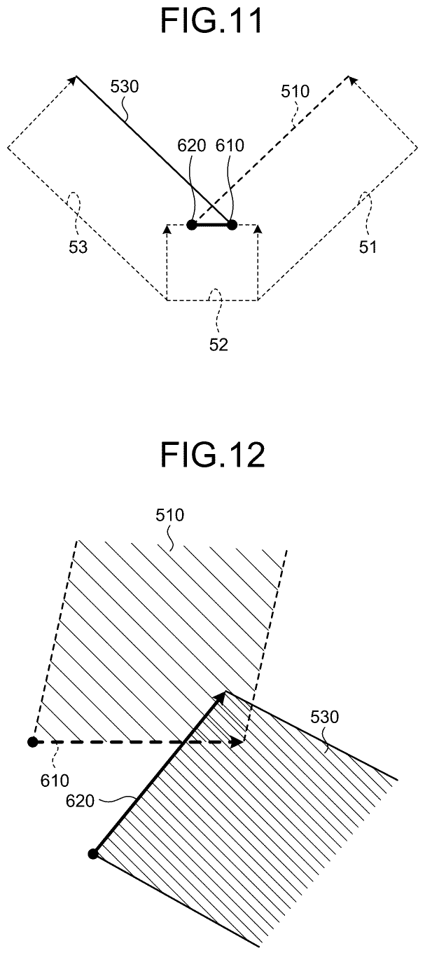

FIG. 11 is a side view schematically illustrating the design surfaces 510, 520, and 530 after being edited and offset. FIG. 12 is a plan view schematically illustrating the design surfaces 510 and 530 after being edited and offset. As illustrated in FIGS. 11 and 12, the design surface 510 and the design surface 530 after being edited and offset may intersect each other depending on relative angles and offset amounts of the design surfaces 510, 520, and 530. When the design surface 510 and the design surface 530 after being edited and offset intersect each other, the design surface 520 does not have an appropriate shape, so that an appropriate target construction surface cannot be generated.

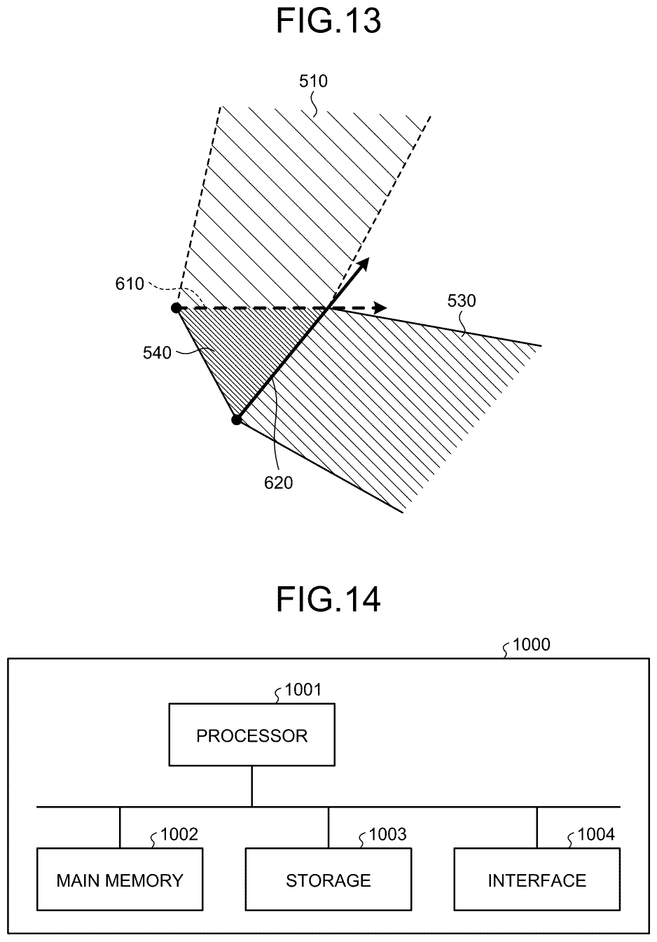

FIG. 13 is a diagram schematically illustrating an example of a processing method when two design surfaces 510 and 530 intersect each other. As illustrated in FIG. 13, when the design surface 510 and the design surface 530 after being edited and offset intersect each other, the offset control unit 24 further edits the design surface 510, the design surface 520, and the design surface 530 after being edited and offset. For example, as illustrated in FIG. 13, the offset control unit 24 edits the design surface 520 after being edited and offset into a triangular shape to fill a blank portion between the first side 610 and the fifth side 620 illustrated in FIG. 12. The triangular shape is defined as a design surface 540. The offset control unit 24 reduces the side 610, that is one side of the design surface 510 after being edited and offset, to match one side of the design surface 540 on the design surface 510. The offset control unit 24 reduces the side 620, that is one side of the design surface 530 after being edited and offset, to match one side of the design surface 540 on the design surface 530. The design surface 510, the design surface 520, and the design surface 530 after being edited and offset are further edited, so that a target construction surface is appropriately generated.

### [Computer System]

FIG. 14 is a block diagram illustrating a computer system 1000 according to the embodiment. The control device 12 described above includes the computer system 1000. The computer system 1000 includes a processor 1001 such as a central processing unit (CPU), a main memory 1002 including a nonvolatile memory such as a read only memory (ROM) and a volatile memory such as a random access memory (RAM), a storage 1003, and an interface 1004 including an input/output circuit. The function of the control device 12 described above is stored in the storage 1003 as a computer program. The processor 1001 reads the computer program from the storage 1003, loads the computer program in the main memory 1002, and executes the above-described processing according to the program. Note that the computer program may be distributed to the computer system 1000 via a network.

According to the above-described embodiment, the computer program or the computer system 1000 can execute: storing a plurality of design surfaces set as a construction object of the excavator 1; selecting at least two design surfaces 51, 52, and 53 to be offset in the directions that are perpendicular to the design surfaces from among the plurality of design surfaces; and editing the selected design surfaces 51, 52, and 53 and offsetting the design surfaces 51, 52, and 53 in the perpendicular directions.

### [Effects]

As described above, the control system 30 of the excavator 1 according to the embodiment includes the construction data storage unit 15 that stores a plurality of design surfaces set as a construction object of the excavator 1, the selection unit 23 that selects at least two design surfaces 51, 52, and 53 to be offset in the directions that are perpendicular to the design surfaces from among the plurality of design surfaces, the offset control unit 24 that edits the selected design surfaces 51, 52, and 53 and offsets the design surfaces 51, 52, and 53 in the perpendicular directions, and the working equipment control unit 28 that controls the working equipment 5 included in the excavator 1 based on the design surfaces 510, 520, and 530 after being edited and offset.

In the embodiment, each of the plurality of design surfaces 51, 52, and 53 is easily offset in a perpendicular direction while a computational load is suppressed. In addition, the design surfaces 51, 52, and 53 are edited and are offset in the perpendicular directions based on a predetermined rule, whereby the design surfaces 510, 520, and 530 that do not intersect each other or are not separated from each other are generated. Since the design surfaces 510, 520, and 530 do not intersect each other or are not separated from each other, the target construction surface is appropriately generated.

### OTHER EMBODIMENTS

In the above-described embodiment, each of the construction data storage unit 15, the vehicle body data storage unit 16, the operation data acquisition unit 17, the input data acquisition unit 18, the sensor data acquisition unit 19, the position/azimuth calculation unit 20, the inclination angle calculation unit 21, the working equipment position calculation unit 22, the selection unit 23, the offset control unit 24, the display control unit 25, the traveling control unit 26, the swing control unit 27, and the working equipment control unit 28 may be configured by separate hardware.

In the above-described embodiment, the work machine 1 is an excavator including the traveling body 3 and the swing body 4. The work machine 1 may not include the traveling body 3 and the swing body 4. The work machine 1 only needs to have a working equipment, and may be, for example, a bulldozer or a wheel loader.

### REFERENCE SIGNS LIST

1 EXCAVATOR (WORK MACHINE)
2 CAB
3 TRAVELING BODY
3A CRAWLER BELT
4 SWING BODY
5 WORKING EQUIPMENT
5A BOOM
5B ARM
5C BUCKET
6 HYDRAULIC CYLINDER
6A BOOM CYLINDER
6B ARM CYLINDER
6C BUCKET CYLINDER
7 OPERATING DEVICE
7A LEFT WORKING LEVER
7B RIGHT WORKING LEVER
7C LEFT TRAVELING LEVER
7D RIGHT TRAVELING LEVER
7E LEFT FOOT PEDAL
7F RIGHT FOOT PEDAL
8 IN-VEHICLE MONITOR
8A DISPLAY DEVICE
8B INPUT DEVICE
8C ALARM DEVICE
9 POSITION SENSOR
9A FIRST POSITION SENSOR
9B SECOND POSITION SENSOR
10 INCLINATION SENSOR
11 POSTURE SENSOR
11A FIRST POSTURE SENSOR
11B SECOND POSTURE SENSOR
11C THIRD POSTURE SENSOR
12 CONTROL DEVICE
14 DRIVER SEAT
15 CONSTRUCTION DATA STORAGE UNIT
16 VEHICLE BODY DATA STORAGE UNIT
17 OPERATION DATA ACQUISITION UNIT
18 INPUT DATA ACQUISITION UNIT
19 SENSOR DATA ACQUISITION UNIT
20 POSITION/AZIMUTH CALCULATION UNIT
21 INCLINATION ANGLE CALCULATION UNIT
22 WORKING EQUIPMENT POSITION CALCULATION UNIT
23 SELECTION UNIT
24 OFFSET CONTROL UNIT
25 DISPLAY CONTROL UNIT
26 TRAVELING CONTROL UNIT
27 SWING CONTROL UNIT
28 WORKING EQUIPMENT CONTROL UNIT
30 CONTROL SYSTEM
50 TARGET CONSTRUCTION SURFACE
51 DESIGN SURFACE (FIRST DESIGN SURFACE)
51F VERTEX
52 DESIGN SURFACE (SECOND DESIGN SURFACE)
53 DESIGN SURFACE (THIRD DESIGN SURFACE)
53F VERTEX
61 SIDE
62 SIDE
510 DESIGN SURFACE
520 DESIGN SURFACE
530 DESIGN SURFACE
540 DESIGN SURFACE
610 FIRST SIDE
612 SECOND SIDE
613 THIRD SIDE
614 FOURTH SIDE
620 FIFTH SIDE
623 NINTH SIDE
624 TENTH SIDE
632 SIXTH SIDE
633 SEVENTH SIDE
634 EIGHTH SIDE
1000 COMPUTER SYSTEM
1001 PROCESSOR
1002 MAIN MEMORY
1003 STORAGE
1004 INTERFACE
Og SITE REFERENCE POINT
Om REPRESENTATIVE POINT
RX SWING AXIS

1. A control system of a work machine, the control system comprising:
a construction data storage unit that stores a plurality of design surfaces set as a construction object of the work machine;
a selection unit that selects at least two design surfaces to be offset in directions that are perpendicular to the design surfaces from among the plurality of design surfaces; and
an offset control unit that edits the selected design surfaces and offsets the edited design surfaces in the perpendicular directions.

2. The control system of a work machine according to claim 1, further comprising
a working equipment control unit that controls working equipment provided in the work machine based on the design surfaces after being edited and offset.

3. The control system of a work machine according to claim 1, further comprising
a display control unit that causes a display device to display the design surfaces.

4. The control system of a work machine according to claim 1, wherein
the selection unit selects a first design surface, a second design surface adjacent to the first design surface, and a third design surface adjacent to at least one of the first design surface and the second design surface.

5. The control system of a work machine according to claim 1, wherein
editing of the design surfaces includes forming each of the design surfaces after being offset into a quadrangle based on vertices of each of the design surfaces before being offset.

6. The control system of a work machine according to claim 4, wherein
the third design surface is adjacent to the first design surface, and
when the second design surface and the third design surface after being edited and offset intersect each other, the offset control unit further edits the first design surface, the second design surface, and the third design surface after being edited and offset.

7. A work machine comprising
the control system of a work machine according to claim 1.

8. A control method of a work machine, the method comprising:
storing a plurality of design surfaces set as a construction object of the work machine;
selecting at least two design surfaces to be offset in directions that are perpendicular to the design surfaces from among the plurality of design surfaces; and
editing the selected design surfaces and offsetting the edited design surfaces in the perpendicular directions.

9. The control method of a work machine according to claim 8, further comprising
controlling working equipment provided in the work machine based on the design surfaces after being edited and offset.

10. The control method of a work machine according to claim 8, further comprising
causing a display device to display the design surfaces.

11. The control method of a work machine according to claim 8, wherein
a first design surface, a second design surface adjacent to the first design surface, and a third design surface adjacent to at least one of the first design surface and the second design surface are selected.

12. The control method of a work machine according to claim 8, wherein
editing of each of the design surfaces includes forming each of the design surfaces into a quadrangle based on vertices of each of the design surfaces.

13. The control method of a work machine according to claim 11, wherein
the third design surface is adjacent to the first design surface, and
when the second design surface and the third design surface after being edited and offset intersect each other, the first design surface, the second design surface, and the third design surface after being edited and offset are further edited.
